(19) United States
(12) Patent Application Publication
(10) Pub. No.: US 2026/0310803 A1
(43) Pub. Date: Oct. 8, 2026

(54) Encryption Attribute Centralization In a Distributed Network Environment

(71) Applicant: Protegrity US Holding, LLC, Stamford, CT (US)

(72) Inventors: Yigal Rozenberg, Wilton, CT (US); David Clyde Williamson, Great Missenden (GB)

(21) Appl. No.: 19/630,448

(22) Filed: Mar. 27, 2026

Related U.S. Application Data
(60) Provisional application No. 63/783,834, filed on Apr. 4, 2025.

(51) Int. Cl. G06F 21/60

(52) U.S. Cl. CPC G06F 21/602

(57) ABSTRACT

Encrypted data attributes can be stored and managed with a central database system. A request from a security system to store a set of attributes, for instance including an encrypted data identifier, a classification, and an encryption operation identifier, can be received by a central attribute database. These attributes are mapped to a unique identifier, which is returned to the security system to replace header information associated with the encrypted data. Upon receiving a subsequent access request from a requesting system that includes the unique identifier, the central database verifies that the requesting system is authorized to access the set of attributes and, if confirmed, provides the corresponding set of attributes to the requesting system. This approach enhances data security and streamlines the controlled access to encrypted data attributes.

### CROSS REFERENCE TO RELATED APPLICATIONS

This application claims the benefit of U.S. Provisional Application No. 63/783,834, filed Apr. 4, 2025, which is incorporated by reference in its entirety.

### TECHNICAL FIELD

The disclosure generally relates to the field of data security, and specifically to the centralized storage of encrypted data attributes in a distributed network environment.

### BACKGROUND

Encrypted data is typically recognized and processed only by the applications that use it, as it is stored as a binary buffer. The data is encrypted using a public key and decrypted using a private key, with each application responsible for performing the decryption as needed. In database systems, encrypted or tokenized data cannot be treated as a standard data type because it cannot be sorted, searched, or combined with clear-text data in operations. While existing systems allow for user-defined data types, these are often limited to the systems in which they are created, restricting interoperability. As a result, handling encrypted data requires specialized pre-processing of the encrypted data by each application or system that uses the encrypted data. This lack of standardization poses challenges in managing encrypted data across different environments.

### BRIEF DESCRIPTION OF DRAWINGS

The disclosed embodiments have other advantages and features which will be more readily apparent from the detailed description, the appended claims, and the accompanying figures(or drawings). A brief introduction of the figures is below.

FIG. 1 is an example high-level block diagram of a system environment in which a central database system operates.

FIG. 2 is an example system architecture for a central database system.

FIG. 3 is an example interaction diagram illustrating the centralized management of encryption attributes.

FIG. 4 is an example mapping table of unique identifiers corresponding to a set of attributes for encrypted data in a central database system.

FIG. 5 is an example flow chart illustrating a process for the centralized management of encryption attributes by a central database system.

### DETAILED DESCRIPTION

The Figures(FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. A letter after a reference numeral, such as “120A,” indicates that the text refers specifically to the element having that particular reference numeral. A reference numeral in the text without a following letter, such as “120,” refers to any or all of the elements in the figures bearing that reference numeral.

The figures depict embodiments of the disclosed system (or method) for purposes of illustration only. One skilled in the art will readily recognize from the following description that alternative embodiments of the structures and methods illustrated herein may be employed without departing from the principles described herein.

### SYSTEM ENVIRONMENT

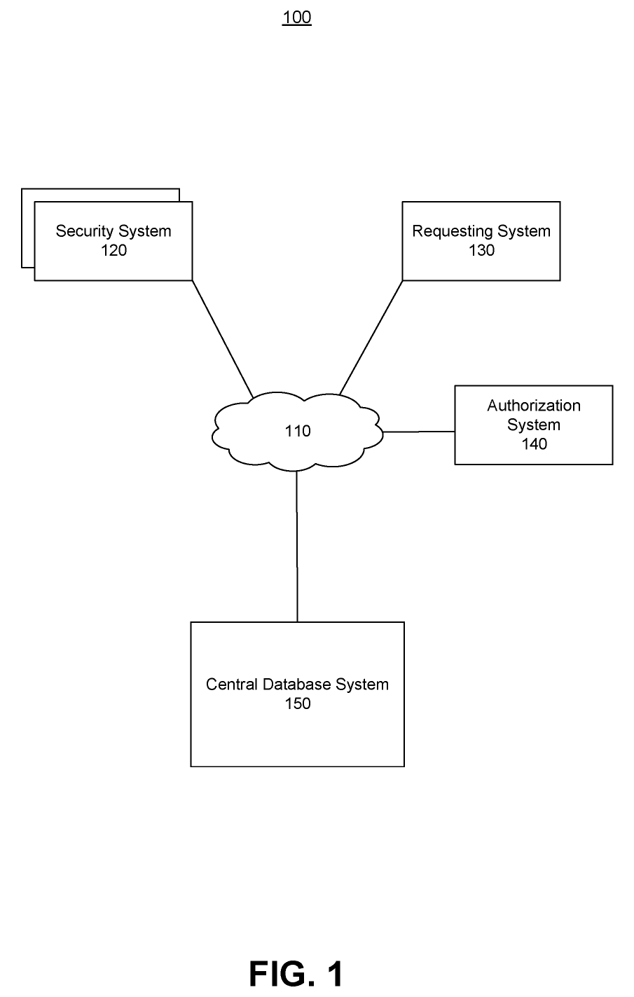

FIG. 1 is an example high-level block diagram of a system environment in which a central database system operates. The system environment 100 also includes a network 110, a security system 120, a requesting system 130, an authorization system 140, and a central database system 150. In some embodiments, the system environment 100 includes components other than those described herein. For clarity, although FIG. 1 only shows one security system 120 and one requesting system 130. alternate embodiments of the system environment 100 can have any number of security systems and/or requesting systems. Additional components such as web servers, network interfaces, load balancers, failover servers, management and network operations consoles and the like are not shown so as to not obscure the details of the system environment.

The network 110 transmits data within the system environment 100. The network 110 transmits data packets between a plurality of network nodes, including the security system 120, the requesting system 130, and the central database system 150. The network 110 may operate as either a Local Area Network (LAN) or Wide Area Network (WAN) using wireless or wired communication systems. In some embodiments, the network 110 transmits data over a single connection (e.g., a data component of a cellular signal, or Wi-Fi, among others), or over multiple connections. The network 110 may include encryption capabilities to ensure the security of data transmitted through the system environment 100. For example, encryption technologies may include secure sockets layers (SSL), transport layer security (TLS), virtual private networks (VPNs) and Internet Protocol security (IPsec), among others.

The security system 120 may be a system (an external entity) owned by an institution (e.g., corporation, partnership, law firm, organization, etc.), individual or set of individuals that legally has access to, uses and/or stores sensitive data, encrypted data, data to be encrypted, or any other suitable data. For example, the security system 120 may be a government agency with a database including records such as personal identification numbers, personal history information, surveillance data, or other classified information. Likewise, the security system 120 may be a company with sensitive database, financial, transaction, or tax records associated with its consumers, suppliers, and vendors.

The security system 120 manages the encryption and decryption of sensitive data (e.g., authentication credentials, personal information, financial records, etc.), and generates metadata associated with the encrypted data. In various embodiments, the security system 120 may employ security policies (such as access control policies and key management policies) to prevent unauthorized access to sensitive data. Likewise, in some embodiments, these systems may further monitor and audit data flow to detect unauthorized access attempts and/or malicious activities. The security system 120, in conjunction with one or more other systems of the environment of FIG. 1, may receive requests to modify one or more security policies, for instance by adding, deleting, or updating encryption keys and/or decryption keys. Likewise, the systems of FIG. 1 may allow key management procedures to be altered, encryption and/or decryption operations to be modified, data sensitivity levels to be reclassified or modified, and the like.

The requesting system 130 communicates with one or more devices that are connected to the network 110, and can receive or access encrypted data (such as the data encrypted by and originating from the security system 120). The requesting system 130 can, in response to receiving or accessing encrypted data, access a unique identifier from a header of the encrypted data, and can request a set of attributes corresponding to the encrypted data from the central database system 150. Example requesting systems 130 can include conventional computer systems (such as a desktop or a laptop computer, a server, a cloud computing device, and the like), mobile computing devices (such as smartphones, tablet computers, mobile devices, and the like), or any other systems with computer functionality. The components of the requesting system 130 are configured to communicate via the network 110, for example a native application executed on the requesting system 130 or through an application programming interface (API) running on a native operating system of the requesting system 130.

The authorization system 140 is configured to determine what entities can access the encrypted data and what level of access each entity has to the encrypted data in decrypted form. Although the authorization system 140 is shown in the embodiment of FIG. 1 as a separate system, in other embodiments, the authorization system 140 can be implemented or included within any of the security system 120, the requesting system 130, or the central database system 150. In some embodiments, the authorization system 140 fields requests from the requesting system 130 to authorize a user of the requesting system 130 to access encrypted data in decrypted form, and provides an indication of the authorization based on characteristics of the encrypted data (such as the data classification) and characteristics of the user of the requesting system 130 (such as the security credentials, title, or affiliation of the user).

In some embodiments, the authorization system 140 leverages the data classification included within the set of attributes associated with encrypted data to determine whether and how a user can access the encrypted data, and specifically, what level of access the user has to the encrypted data in decrypted form. In such embodiments, the authorization system 140 can access a data access policy, for instance from the security system 120, from the central database system 150, or stored within the authorization system 140. The data access policy can identify which data classifications correspond to various forms of decrypted data. For instance, in some embodiments, a data classification of “public” can allow a user without security credentials to access decrypted data in plain text. Likewise, a data classification of “sensitive” can allow a user without security credentials to access decrypted data in masked form while allowing a different user with a security clearance to access the data in plain text. The authorization system 140, in response to determining that a user is allowed to access encrypted data in a particular decrypted form (plaintext, masked text, ciphertext, obfuscated, or any other suitable form) can provide an indication of the authorization and the decrypted data form to the requesting system 130 or any other system associated with a user requesting access to the data.

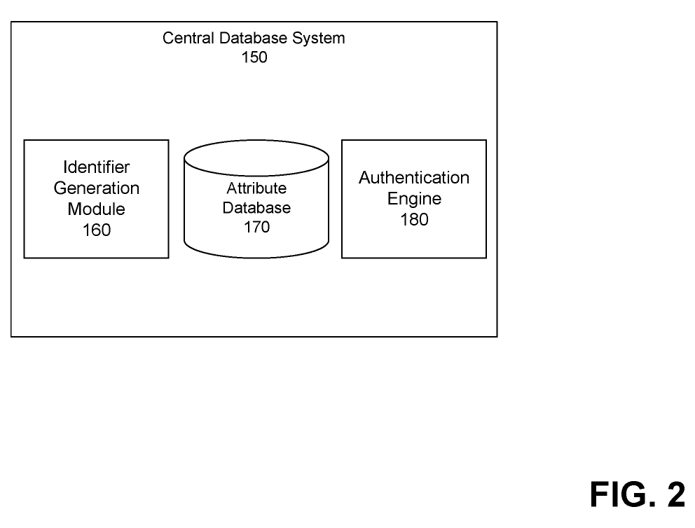

The central database system 150 receives requests to store attributes associated with encrypted data from a security system 120 through the network 110, generates a unique identifier in response, maps the set of attributes to the unique identifier, and provides the unique identifier to the security system 120 for storage within a header of the encrypted data. Likewise, the central database system 150 is configured to receive a request for a stored set of attributes from a requesting system 130, to authenticate that the requesting system 130 is authorized to access the set of attributes, to query an attribute table or mapping table using the unique identifier to identify the requested set of attributes, and to provide the set of attributes to the requesting system 130 in response. The central database system 150 is described in greater detail below in conjunction with the description of FIG. 2

### SYSTEM ARCHITECTURE FOR CENTRALIZED DATABASE SYSTEM

FIG. 2 is an example system architecture for a central database system. The system architecture illustrated in FIG. 2 includes an identifier generation module 160, an attribute database 170 and an authentication engine 180. Alternative embodiments may include more, fewer, or different components from those illustrated in FIG. 2, and the functionality of each component may be divided between the components differently from the description below. For instance, the central database system 150 can include an interface engine (not illustrated in the example embodiment of FIG. 2) that can facilitate communication between the central database system and the other systems of FIG. 1, for example by receiving requests from the security system 120 to store sets of attributes associated with encrypted data and by providing the sets of attributes to a requesting system 130 in response to a request from and authenticating the requesting system 130. Additionally, each component may perform their respective functionalities in response to a request from a human or automatically without human intervention.

The central database system 150 receives a request from a security system 120 to store a set of attributes corresponding to encrypted data. Data is encrypted using one or more encryption operations, tokenization operations, and the like to convert the data into a format that can only be read by authorized entities (such as entities with access to decryption keys, tokenization tables used to tokenize the data, and the like). Encrypted data can include two components: the header and the payload. The header contains metadata about the data (referred to herein as a “set of attributes”), such as authentication details and/or encryption algorithms, while the payload includes the encrypted data content. The set of attributes in the header can include a recipient of encrypted data information representative of the encrypted data, information describing how to decrypt the encrypted data, information describing how to be authenticated to access the encrypted data, and the like.

In one embodiment, the set of attributes includes a data identifier, a data classification, and an encryption identifier. The data identifier includes a category or data type represented by the encrypted data, such as a government issued identification number (e.g., SSN, driver’s license number, passport identification number etc.), a physical address, an electronic mail address, a geographical location, a phone number, a device identifier (e.g., IP address, MAC address, IMEI, etc.), a date, a time, a representation of financial information, and any other suitable type, form, or format of information.

In one embodiment, the data classification includes one or more of a data classification level (e.g., public, private, restricted etc.), a data security level, a data origin, a data ownership or a data format type (e.g., text, binary, JSON, etc.) corresponding to the encrypted data. In one embodiment, the encryption identifier corresponds to an encryption operation used to generate the encrypted data, such as an encryption operation type, a hashing function type, and/or a tokenization operation.

The central database system 150, in response to receiving a request to store a set of attributes corresponding to encrypted data (for instance, from the security system 120), is configured to generate a unique identifier corresponding to the set of attributes using the identifier generation module 160. The unique identifier distinguishes a set of attributes stored by the central database system 150 from other stored sets of attributes. In various embodiments, the unique identifier may be generated using various methods such as Universally Unique Identifier (UUID), Chronologically Ordered Globally Unique Identifier (Comb GUID), hash-based functions (e.g., MD5, SHA 256, etc.), and/or random string/integer generating functions.

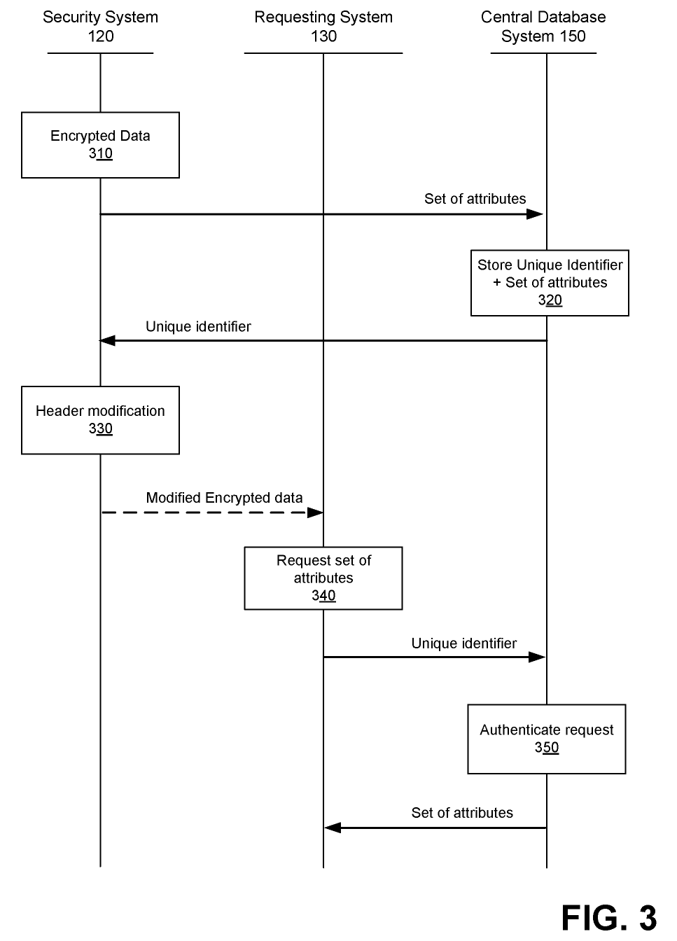

The central database system 150, after generating the unique identifier for a received set of attributes, is configured to store the set of attributes in association with the unique identifier within the attribute database 170. The attribute database 170 can include an attribute table or a mapping table that maps a unique identifier to the corresponding set of attributes. In some embodiments, the attribute table or mapping table includes a first field for storing the unique identifier and a corresponding set of fields for storing a data identifier representative of a type or category of the encrypted data, for storing a data classification corresponding to the encrypted data, and for storing an encryption identifier corresponding to a type of encryption operation performed to produce the encrypted data. An example mapping or attribute table is illustrated below in association with FIG. 3.

The central database system 150, in response to receiving a request to access a set of attributes corresponding to encrypted data (for instance, from a requesting system 130) is configured to authenticate the request by determining if the requesting system 130 is authorized to access the set of attributes. In some embodiments, the request from the requesting system 130 includes the unique identifier. The authentication engine 180 authenticates the request, for instance by identifying the set of attributes stored within the attribute database 170 using the unique identifier, by identifying a data classification associated with the set of attributes, and by determining that the requesting system 130 satisfies requirements corresponding to the data classification. In some embodiments, the authentication engine 180 authenticates the requesting system 130 by determining that the requesting system 130 includes valid access credentials (such as a username and password), by determining that the requesting system 130 corresponds to an authenticated user or a user account, by determining that the requesting system 130 makes the request from an authenticated network, or using any other sufficient criteria. Once the central database system 150 authenticates the requesting system 130, the central database system 150 provides the set of attributes to the requesting systems 130.

It should be noted that in some embodiments, the central database system 150 can modify multiple sets of attributes stored within the attribute database 170 with one attribute modification operation (for example, in response to a request from a security system 120 or another entity associated with the central database system 150 or associated with an entity corresponding to encrypted data with sets of attributes stored within the attribute database 170). For instance, the central database system 150 can change a data classification for multiple sets of attributes, for instance by changing all sets of attributes that include a “sensitive” data classification to a “public” data classification, or by changing all sets of attributes corresponding to a particular security system 120 that include a “restricted” data classification to a “classified” data classification. In such embodiments, the reclassification of data, the modification of attribute access criteria, or the modification of any other aspects of the sets of attributes can be streamlined in a single modification operation (as opposed to requiring multiple modification operations, one for each set of attributes stored within the attribute database 170).

FIG. 3 is an example interaction diagram illustrating the centralized management of encryption attributes. It should be noted that in other embodiments, the operations described in association with FIG. 3 may be performed in different orders or by different systems. A security system 120 generates 310 encrypted data, for instance by performing an encryption operation on sensitive data. The encrypted data includes a header, which stores a set of attributes representative of the encrypted data, and a payload, which includes the encrypted data content. The security system 120 then provides the set of attributes to the central database system 150, for instance with a request to store the set of attributes.

The central database system 150 receives the request from the security system 120 to store the set of attributes corresponding to the encrypted data. Upon receiving the request, the central database system 150 generates and stores 320 a unique identifier mapped to the corresponding set of attributes, for instance within a mapping table or attribute table. The central database system 150 provides the unique identifier to the security system 120, which modifies 330 the header of the encrypted data by replacing the set of attributes within the header with the unique identifier. It should be noted that in some embodiments, the unique identifier can include an identifier for the central database system 150 (such as an IP address, URL, name, or other identifying information) that allows entities to locate the central database system 150 to obtain the set of attributes using the unique identifier.

At a later time, a requesting system 130 receives the modified encrypted data, either directly from the security system 120, or from another system. The requesting system 130 may need to access the set of attributes associated with the modified encrypted data, for instance in order to determine a classification associated with the encrypted data or to decrypt the encrypted data. The requesting system 130 requests 340 the set of attributes, for instance by accessing the unique identifier from the modified encrypted data and sending the unique identifier the central database system 150. The central database system 150 authenticates 350 the request, for instance by checking if the requesting system 130 possesses sufficient access credentials. In response to determining that the requesting system is authorized to access the set of attributes corresponding to the modified encrypted data, the central database system 150 accesses the set of attributes, for instance by querying the mapping table or attribute table using the unique identifier, and provides the set of attributes to the requesting system 130. The requesting system 130 may in some embodiments modified the modified encrypted data by replacing the unique identifier within the header of the modified encrypted data with the set of attributes received from the central database system 150.

In one embodiment, the central database system 150 may receive a request to modify a classification. For example, in a government agency, sensitive data, such as personal identification numbers, may initially be classified at a security level (e.g., level 4, which might represent moderate sensitivity). This data is stored in the central database system 150 with an associated unique identifier. Later, if an individual's circumstances change, such as their security clearance increasing or decreasing, a modification request is sent to the central database system 150 to update the security level from level 4 to a different level, such as level 2, indicating a higher clearance. In response, the central database system 150 may check the unique identifier to locate all relevant entries in the attribute database and updates the security classification for all associated data, ensuring the new security level (e.g., "level 2") is applied consistently across all records mapped to that unique identifier.

In another embodiment, the central database system 150 may receive a request from the security system 120 to modify the classification for all sets of attributes in the attribute database associated with the security system 120 and corresponding to a specific classification type. For example, in a financial institution, a customer’s sensitive data, such as account numbers or credit card information, is initially classified as "sensitive", and attributes corresponding to such data once encrypted is stored in the attribute database 170 within the central database system 150, mapped to a unique identifier. The institution later determines that the customer’s data needs a higher level of security due to regulatory changes or risk factors. A modification request is sent from the security system 120 to the central database system 150 to update the classification from "sensitive" to "extremely sensitive". In response, the central database system 150 update the security classification within attributes corresponding to all customer data associated with the financial institution (but not data associated with other entities).

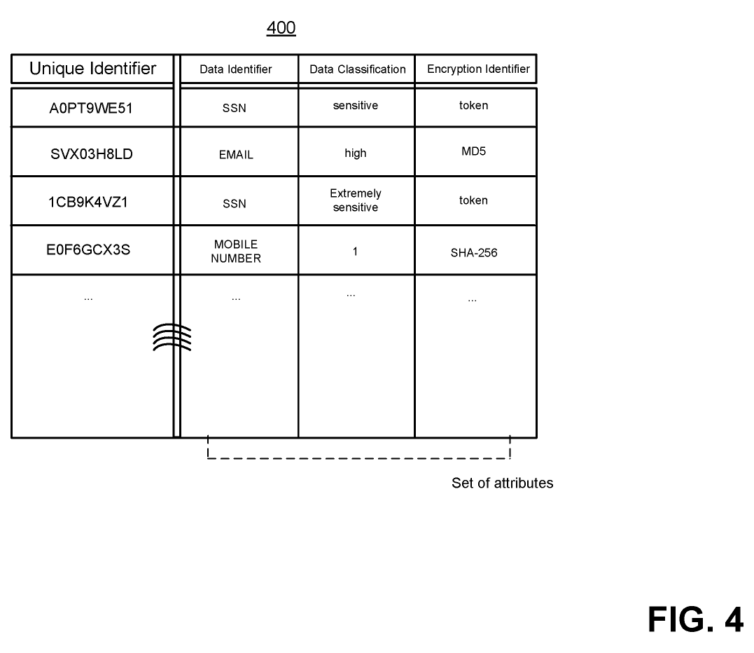

FIG. 4 is an example mapping table 400 of unique identifiers corresponding to a set of attributes associated with encrypted data in central database system. The central database system 150 stores and manages sets of attributes associated with encrypted data. As noted above, the sets of attributes are mapped to unique identifiers within an attribute table or mapping table. The central database system 150 may receive a request 340 including a unique identifier to access the set of attributes corresponding to the unique identifier, from the requesting system 130. The central database system 150 then authenticate 350 whether the requesting system 130 is authorized to access the requested set of attributes (e.g., by determining if the requesting system has validated authorization credentials, has entered a correct username and/or password, is on an authentication whitelist, and the like).

For example, a request to access a set of attributes can include a unique identifier, such as "A0PT9WE51" which corresponds to a record containing the following attributes: the data identifier "SSN," the data classification "sensitive," and the encryption identifier "token". The central database system 150 authenticates the request by verifying whether the requesting system from which the unique identifier "A0PT9WE51" is received has rights to access the associated set of attributes. For instance, the central database system 150 checks the security clearance associated with the requesting entity and the security clearance requirements associated with the data classification corresponding to the unique identifier to confirm that the requesting system 130 is authorized.

Upon verification, the central database system 150 retrieves the set of attributes associated with "A0PT9WE51" (for instance, by querying the mapping table 400) which includes the “SSN”, marked as "sensitive" classification and encrypted with a “token”. The central database system 150 then provides the set of attributes to the requesting system 130.

However, when the requesting system submits a request with the unique identifier "SVX03H8LD" which corresponds to attributes with the classification "extremely sensitive," the central database system 150 determines that the security clearance associated with the requesting system 130 is not sufficient to access the corresponding set of attributes. As a result, the central database system 150 denies the request and does not provide the set of attributes associated with the unique identifier "SVX03H8LD".

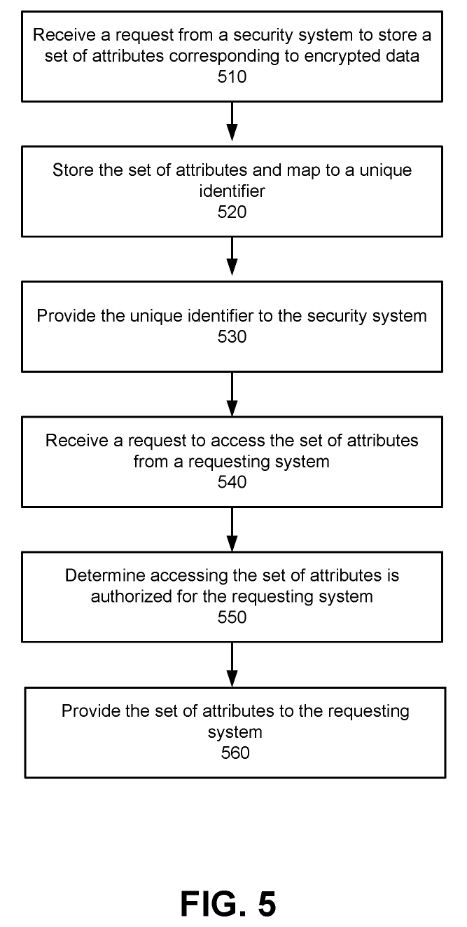

FIG. 5 is an example flow chart illustrating a process for the centralized management of encryption attributes by a central database system. The central database system 150 receives 510 a request from a security system 120 to store a set of attributes corresponding to encrypted data. The central database system 150 stores 520 the set of attributes and maps the stored attributes to a unique identifier, for instance with an attribute table of the central database system. The central database system 150 provides 530 the generated unique identifier to the security system 120, which modifies the header of the encrypted data by replacing the set of attributes with the unique identifier.

The central database system 150 subsequently receives 540 a request from a requesting system 130 to access the set of attributes associated with the encrypted data. The request can include the unique identifier. The central database system 150 determines 550 whether the requesting system 130 is authorized to access the set of attributes associated with the received unique identifier. In response to determining that the requesting system 130 is authorized to access the set of attributes, the central database system 150 retrieves the set of attributes associated with the unique identifier from the attribute table and provides 560 the set of attributes to the requesting system 130.

### ADDITIONAL CONFIGURATION CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, by a central database system, a request from a security system to store a set of attributes corresponding to encrypted data, the set of attributes comprising an identifier corresponding to the encrypted data, a classification corresponding to the encrypted data, and an encryption identifier corresponding to an encryption operation used to generate the encrypted data;
storing, by the central database system, the set of attributes in an attribute database such that the set of attributes is mapped to a unique identifier corresponding to the set of attributes;
providing, by the central database system, the unique identifier to the security system, the security system configured to replace header information associated with the encrypted data with the unique identifier;
receiving, by the central database system, a request to access the set of attributes from a requesting system, the request including the unique identifier;
determining, by the central database system, that the requesting system is authorized to access the set of attributes; and
in response to determining that the requesting system is authorized to access the set of attributes, accessing, by the central database system, the set of attributes by querying the attribute database with the unique identifier to retrieve the set of attributes and providing the set of attributes to the requesting system.

2. The method of claim 1, wherein the identifier comprises a category or data type represented by the encrypted data.

3. The method of claim 2, wherein the category or data type comprises one or more of: a government issued identification number, a physical address, an electronic mail address, a geographical location, a phone number, a device identifier, and an individual identifying element.

4. The method of claim 1, wherein the classification comprises one or more of a data security level, a data classification level, a data origin, a data ownership, or a data format type.

5. The method of claim 1, wherein the encryption identifier comprises one or more of an encryption operation type, a hashing function type, or a tokenization operation.

6. The method of claim 1, wherein the central database system, in response to receiving a modification to a classification type, is configured to modify the classification for all sets of attributes in the attribute database corresponding to the classification type.

7. The method of claim 1, wherein the central database system, in response to receiving a modification to a classification type from the security system, is configured to modify the classification for all sets of attributes in the attribute database associated with the security system and corresponding to the classification type.

8. A central database system comprising a hardware processor and a non-transitory computer-readable storage medium storing executable instructions that, when executed by the hardware processor, cause the hardware processor to perform steps comprising:
receiving, by the central database system, a request from a security system to store a set of attributes corresponding to encrypted data, the set of attributes comprising an identifier corresponding to the encrypted data, a classification corresponding to the encrypted data, and an encryption identifier corresponding to an encryption operation used to generate the encrypted data;
storing, by the central database system, the set of attributes in an attribute database such that the set of attributes is mapped to a unique identifier corresponding to the set of attributes;
providing, by the central database system, the unique identifier to the security system, the security system configured to replace header information associated with the encrypted data with the unique identifier;
receiving, by the central database system, a request to access the set of attributes from a requesting system, the request including the unique identifier;
determining, by the central database system, that the requesting system is authorized to access the set of attributes; and
in response to determining that the requesting system is authorized to access the set of attributes, accessing, by the central database system, the set of attributes by querying the attribute database with the unique identifier to retrieve the set of attributes and providing the set of attributes to the requesting system.

9. The central database system of claim 8, wherein the identifier comprises a category or data type represented by the encrypted data.

10. The central database system of claim 9, wherein the category or data type comprises one or more of: a government issued identification number, a physical address, an electronic mail address, a geographical location, a phone number, a device identifier, and an individual identifying element.

11. The central database system of claim 8, wherein the classification comprises one or more of a data security level, a data classification level, a data origin, a data ownership, or a data format type.

12. The central database system of claim 8, wherein the encryption identifier comprises one or more of an encryption operation type, a hashing function type, or a tokenization operation.

13. The central database system of claim 8, wherein the central database system, in response to receiving a modification to a classification type, is configured to modify the classification for all sets of attributes in the attribute database corresponding to the classification type.

14. The central database system of claim 8, wherein the central database system, in response to receiving a modification to a classification type from the security system, is configured to modify the classification for all sets of attributes in the attribute database associated with the security system and corresponding to the classification type.

15. A non-transitory computer-readable storage medium storing executable instructions that, when executed by a hardware processor of a central database system, cause the hardware processor to perform steps comprising:
receiving, by the central database system, a request from a security system to store a set of attributes corresponding to encrypted data, the set of attributes comprising an identifier corresponding to the encrypted data, a classification corresponding to the encrypted data, and an encryption identifier corresponding to an encryption operation used to generate the encrypted data;
storing, by the central database system, the set of attributes in an attribute database such that the set of attributes is mapped to a unique identifier corresponding to the set of attributes;
providing, by the central database system, the unique identifier to the security system, the security system configured to replace header information associated with the encrypted data with the unique identifier;
receiving, by the central database system, a request to access the set of attributes from a requesting system, the request including the unique identifier;
determining, by the central database system, that the requesting system is authorized to access the set of attributes; and
in response to determining that the requesting system is authorized to access the set of attributes, accessing, by the central database system, the set of attributes by querying the attribute database with the unique identifier to retrieve the set of attributes and providing the set of attributes to the requesting system.

16. The non-transitory computer-readable storage medium of claim 15, wherein the identifier comprises a category or data type represented by the encrypted data.

17. The non-transitory computer-readable storage medium of claim 16, wherein the category or data type comprises one or more of: a government issued identification number, a physical address, an electronic mail address, a geographical location, a phone number, a device identifier, and an individual identifying element.

18. The non-transitory computer-readable storage medium of claim 15, wherein the classification comprises one or more of a data security level, a data classification level, a data origin, a data ownership, or a data format type.

19. The non-transitory computer-readable storage medium of claim 15, wherein the encryption identifier comprises one or more of an encryption operation type, a hashing function type, or a tokenization operation.

20. The non-transitory computer-readable storage medium of claim 15, wherein the central database system, in response to receiving a modification to a classification type, is configured to modify the classification for all sets of attributes in the attribute database corresponding to the classification type.
